(19) United States
(12) Patent Application Publication
(10) Pub. No.: US 2007/0186146 A1
(43) Pub. Date: Aug. 9, 2007

(54) Time-scaling an audio signal

(75) Inventors: Ari Lakaniemi, Helsinki (FI); Pasi Ojala, Kirkkonummi (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/350,253

(22) Filed: Feb. 7, 2006

(51) Int. Cl. G06F 15/00

(52) U.S. Cl. 715/500.1

(57) ABSTRACT

For time-scaling an audio signal that is distributed to a sequence of frames, frames of the sequence of frames are time scaled whenever needed, resulting in a sequence of variable sized frames. An audio signal in the sequence of variable sized frames is then re-divided into a sequence of equal sized frames for further processing.

### FIELD OF THE INVENTION

The invention relates to a method for time-scaling an audio signal. The invention relates equally to a chipset, to an audio receiver, to an electronic device and to a system enabling a time-scaling of an audio signal. The invention relates further to a software program product storing a software code for time-scaling an audio signal.

### BACKGROUND OF THE INVENTION

Time-scaling an audio signal may be enabled for example in an audio receiver that is suited to receive encoded audio signals in packets via a packet switched network, such as the Internet, to decode the encoded audio signals and to playback the decoded audio signal to a user.

The nature of packet switched communications typically introduces variations to the transmission times of the packets, known as jitter, which is seen by the receiver as packets arriving at irregular intervals. In addition to packet loss conditions, network jitter is a major hurdle especially for conversational speech services that are provided by means of packet switched networks.

FIG. 1 is a time chart illustrating a typical voice over Internet Protocol (VoIP) transmission including jitter. A transmitter sends IP packets containing audio frames in regular intervals, as indicated in row a) of FIG. 1. In case of Adaptive MultiRate (AMR) or Adaptive MultiRate WideBand (AMR-WB) speech codec, the transport interval is 20 ms, in case a single audio frame is encapsulated in each packet. Due to the variable network delay, a receiver does not receive the packets as regularly as they are transmitted. A time line indicates the time of reception of each transmitted packet. As can be seen in row b) of FIG. 1, the resulting availability of packets at the receiver is partly spaced apart and partly overlapping.

However, an audio playback component of an audio receiver operating in real-time requires a constant input to maintain an undisturbed audio playback and a good sound quality. Even short interruptions should be prevented. Thus, if some packets comprising audio frames arrive only after the audio frames are needed for decoding and further processing, those packets and the included audio frames are considered as lost. The audio decoder will perform error concealment to compensate for the audio signal carried in lost frames. Obviously, extensive error concealment will reduce the sound quality as well, though.

Typically, a jitter buffer is therefore utilized to hide the irregular packet arrival times and to provide a continuous input to the decoder and a subsequent audio playback component. The jitter buffer stores to this end incoming audio frames for a predetermined amount of time. This time may be specified for instance upon reception of the first packet of a packet stream. In the example of FIG. 1, a buffering of several packets is needed to ensure a regular feed to a decoder in jitter conditions.

A jitter buffer introduces, however, an additional delay component, since the received packets are stored before further processing. This increases the end-to-end delay. A jitter buffer can be characterized by the average buffering delay and the resulting proportion of delayed frames among all received frames.

A jitter buffer using a fixed delay is inevitably a compromise between a low end-to-end delay and a low number of delayed frames under given network conditions, and finding an optimal trade off is not an easy task. This is illustrated in FIGS. 2 and 3.

FIG. 2 is a time chart illustrating a first example of a fixed jitter buffer operation that is used for the variable network delay conditions presented in FIG. 1. In this example, two packets, each containing a single audio frame of 20 ms, are buffered before the decoding process. This causes an additional delay of 40 ms in the system. However, the buffer occupancy diagram in row a) indicates that buffering two frames is not sufficient for the given delay variation. At various instances, the buffer does not receive packets from the network in time, that is, the buffer underflows. In these cases, the decoder receives a ‘no data’ or ‘lost data’ message from the buffer when trying to retrieve the next frame. Thereupon, the decoder performs frame error concealment, as indicated in row b) of FIG. 2.

FIG. 3 is a time chart illustrating a second example of a fixed jitter buffer operation used for the variable network delay conditions presented in FIG. 1. In this example, three packets are buffered before the decoding process. Buffering three packets is suited to avoid the buffer underflow, as indicated in row a) of FIG. 3. As a result, the error concealment can be avoided, as indicated in row b) of FIG. 3. Increasing the buffer length by one packet, however, further increases the overall system delay by 20 ms.

Although there can be special environments and applications, in which the amount of expected jitter can be estimated to remain within predetermined limits, in general the jitter can vary from zero to hundreds of milliseconds—even within the same session. Using a fixed delay that is set to a sufficiently large value to cover the jitter according to an expected worst case scenario would thus keep the number of delayed frames in control, but at the same time there is a risk of introducing an end-to-end delay that is too long to enable a natural conversation.

Therefore, applying a fixed buffering is not the optimal choice in most audio transmission applications operating over a packet switched network.

An adaptive jitter buffer can be used for dynamically controlling the balance between a sufficiently short delay and a sufficiently low number of delayed frames. In this approach, the incoming packet stream is monitored constantly, and the buffering delay is adjusted according to observed changes in the delay behavior of the incoming packet stream. In case the transmission delay seems to increase or the jitter is getting worse, the buffering delay is increased to meet the network conditions. In an opposite situation, the buffering delay can be reduced, and hence, the overall end-to-end delay is minimized.

Since the audio playback component needs a regular input, the buffer adjustment is not completely straightforward, though. A problem arises from the fact that if the buffering delay is reduced, the audio signal that is provided to the playback component needs to be shortened to compensate for the shortened buffering delay, and on the other hand, if the buffering delay is increased, the audio signal has to be lengthened to compensate for the increased buffering delay.

For VoIP applications, it is known to modify the signal in case of an increasing or decreasing of the buffer delay by discarding or repeating a part of the comfort noise signal between periods of active speech when discontinuous transmission (DTX) is enabled. However, such an approach is not always possible. For example, the DTX functionality might not be employed, or the voice activity detector might not switch off the transmission and switch to a comfort noise due to challenging background noise conditions, such as an interfering talker in the background. In this case, the adaptation needs to be done based on audio characteristics only.

In a more advanced solution taking care of a changing buffer delay, a signal time scaling is employed to change the length of the output audio frames that are forwarded to the playback component. The signal time scaling can be realized either inside the decoder or in a post-processing unit after the decoder. In this approach, the frames in the jitter buffer are read more frequently by the decoder when decreasing the delay than during normal operation, while an increasing delay slows down the frame output rate from the jitter buffer.

FIG. 4 illustrates an ideal time scaling of the decoder output that would compensate the delay variations in the packet delivery without using any buffer. An upper diagram of FIG. 4 depicts the network delay over time. The network delay is observed from the time stamps of the received packets. In the presented example, it increases suddenly for a short period of time. A lower diagram of FIG. 4 depicts a time scaling of the decoded frames over time in a way that the audio frame consumption from the buffer compensates the changes in the network delay. To address the increased delay without classifying any packets as lost, the receiver needs to increase the playback time of frames preceding the late arriving frames. In an ideal case, the time scaling is proportional to the delay pattern slope, that is, to the first derivative of the delay pattern.

The challenge in performing time scale modifications in active parts of the audio signal is to keep the perceived audio quality at a sufficiently high level. A time scale modification that requires a relatively low complexity for maintaining a good voice quality can be realized for example with pitch-synchronous mechanisms. In a pitch-synchronous time-scaling, full pitch cycles are repeated or removed to create a scaled signal of a required length.

FIG. 5 is a time chart illustrating decoded and time-scaled frames that are provided for playback. The time chart is provided again for an ideal case where no jitter buffer is used at all. The time scaling functionality takes care of compensating for the transmission delay variations by scaling the signal to fully match the varying reception time. In principle, each decoded frame is thus extended as long as it takes to receive the next frame. However, this approach does not work in practice, since the arrival time of the next frame cannot be known without an additional delay. Consequently, the frame length that is required for providing enough decoded audio until the next frame will be available is not known in advance.

FIG. 6 presents a situation, in which a frame has not been extended sufficiently in the time-scaling due to the lack of knowledge about the reception time of the next frame. As the decoder does not receive the next frame early enough, it needs to perform frame error concealment.

Thus, a practical implementation of a transmission delay compensation by means of time-scaling has to resort to a buffering as well.

FIG. 7 is a time chart illustrating an approach, which employs a fixed jitter buffer delay in combination with an unconstrained time scaling using an optimal frame length for each output frame. Row a) of FIG. 7 presents exemplary buffer occupancy and row b) of FIG. 7 presents the time-scaled output frames. The lengths of these output frames are not necessarily multiples of the length of the input frames, for instance of 20 ms in the case of AMR. Furthermore, for best possible audio quality vs. computational complexity, the time scaling is typically performed by taking into account the current audio signal characteristics, which also has an effect on the length of the scaled frame.

The overall buffering delay resulting with the approach illustrated in FIG. 7 is the same as the overall buffering delay resulting with the approach illustrated in FIG. 2. With an unconstrained time scaling operation, a buffer underflow can be avoided and no frame error concealment is needed. Hence, the advantage of this time scaling control is the maintenance of a constant jitter buffer size and small end-to-end system delay even with changing jitter conditions. That is, the jitter buffer size, and hence the system delay, does not need to be adapted upwards even when the jitter increases.

Still, the audio signal can only be extended or contracted within certain limits without voice quality degradation or decreased intelligibility. If there is a sudden big increase in the network delay, it may not be possible to increase the frame length by a sufficient extent for playback. In this case, the jitter buffer may underflow despite the time scaling capability. As a result, the input frame must be classified as ‘no data’ or ‘lost frame’, and the decoder must perform frame error concealment. This problem can only be avoided by means of a variable buffering delay. A buffering delay adaptation utilizing time scaling requires a logic that estimates the need for an increasing or decreasing buffer delay based on observed network characteristics and on the buffer occupancy.

Any type of time scaling operation, however, causes a variation in the audio playback rate, since the time-scaled frames intended for post-processing and playback are of variable size. Certain platforms are designed for constant audio feed with constant size audio frames. This restriction applies for instance to terminal devices that employ a constant block length for the whole audio processing chain following the audio decoder. In such platforms, the variability of the frame lengths may cause problems.

### SUMMARY OF THE INVENTION

It is an object of the invention to extend the usability of a time-scaling of audio signal frames.

A method for time-scaling an audio signal is proposed, wherein the audio signal is distributed to a sequence of frames. The method comprises time-scaling frames of the sequence of frames whenever needed, resulting in a sequence of variable sized frames. The method further comprises re-dividing an audio signal in this sequence of variable sized frames into a sequence of equal sized frames.

Moreover, a chipset with at least one chip for time-scaling an audio signal that is distributed to a sequence of frames is proposed. The at least one chip comprises a time scaling component adapted to time-scale frames of an input sequence of frames whenever needed, resulting in a sequence of variable sized frames. The at least one chip further comprises a re-dividing component adapted to re-divide an audio signal in a sequence of variable sized frames provided by the time scaling component into a sequence of equal sized frames.

Moreover, an audio receiver comprising a time scaling component and a re-dividing component for time-scaling an audio signal is proposed. The samples of the audio signal are assumed to be distributed to a sequence of frames.

The time scaling component and the re-dividing component are adapted to realize corresponding functions as the time scaling component and the re-dividing component of the proposed chipset. It has to be noted, however, that the time scaling component and the re-dividing component of the audio receiver can be realized by hardware and/or software. One or both components may be implemented for instance in a chipset, or they may be realized by a processor executing corresponding software code.

Moreover, an electronic device comprising a time scaling component and a re-dividing component for time-scaling an audio signal is proposed. Samples of the audio signal are assumed again to be distributed to a sequence of frames. The time scaling component and the re-dividing component of the proposed electronic device correspond to the time scaling component and the re-dividing component of the proposed audio receiver. The electronic device could be for example a pure audio processing device, or a more comprehensive device, like a mobile terminal or a media gateway, etc.

Moreover, a system is proposed, which comprises a transmission network adapted to transmit audio signals, a transmitter adapted to provide audio signals for transmission via the transmission network and a receiver adapted to receive audio signals via the transmission network. The receiver corresponds to the above proposed audio receiver.

Finally, a software program product is proposed, in which a software code for time-scaling an audio signal is stored in a readable medium. The samples of the audio signal are assumed again to be distributed to a sequence of frames. When being executed by a processor, the software code realizes the proposed method. The software program product can be for example a separate memory device, a memory that is to be implemented in an audio receiver, etc.

The invention is based on the idea that the audio data in time scaled frames can be distributed before a further processing to a new sequence of frames, which have equal sizes again.

It is an advantage of the invention that it allows using an unconstrained time scaling as a building block for a processing providing a constrained output. This allows using a computationally efficient and high quality time scaling, even if subsequent processing components require a constant audio block size. Since the provided audio frames are of equal size even when time scaling is utilized, no changes are needed in legacy audio post-processing and playback software or hardware.

The time-scaling may be employed for instance for optimizing the use of an adaptive jitter buffer, and hence, the end-to-end delay.

The time-scaling may comprise for example scaling a given number of frames to fit into a target window of a given size. The given size of the target window is advantageously an integer multiple of the size of the equal sized frames, which is advantageously the same as the size of the original frames that are provided for time-scaling.

Using a target window for the time-scaling has several advantages. When the time scale is extended or contracted within a selected target window, the scaling operation can be distributed in a deterministic way over several frames. Moreover, the scaling will quickly converge to the original frame boundaries so that the target windowing is needed only when the network delay is changing.

The respective given number of frames and the respective given size of the target window for a particular scaling operation may for instance be computed or fetched from a table. At least one of the given number of frames and the given size of the target window may depend on a desired amount of scaling. One of the given number of frames and the given size of the target window could also be set to a fixed value.

Fitting the given number of frames into a target window may comprise for instance the following steps:

a) splitting the target window into a number of equally sized sub-windows corresponding to said given number of frames;

b) fitting a first frame of the given number of frames into a first one of the sub-windows, resulting in a remaining target window;

c) if a next frame of the given number of frames remains, splitting the remaining target window into a number of new equally sized sub-windows corresponding to the remaining number of frames; and

d) fitting the next frame of said given number of frames into a first one of the new sub-windows, resulting in a new remaining target window, and continuing with step c).

A time-scaled last frame of the given number of frames may not fit exactly into the remaining target window. The reason is that the employed time-scaling approach may not allow an arbitrary scaling. For instance, in case of a pitch synchronous time scaling approach, the original frame may only be extended or reduced by one or more pitch periods. Further, if the audio signal is received via a network, detected network characteristics may have to be taken into account in the scaling as well.

In case a time-scaled last frame of the given number of frames exceeds a remaining target window, the exceeding section may be cut off and provided for use in a next target window.

In case a time-scaled last frame of the given number of frames does not fill up a remaining target window, in contrast, a first section of a subsequent frame may be added for filling up the target window.

The audio signal provided for time-scaling may be for example an audio signal that is received via a packet switched network.

The invention can be applied to any audio codec, in particular, though not exclusively, to any speech codec, like an AMR and AMR-WB codec.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a time chart illustrating the transmission and reception of audio packets in a transmission system;

FIG. 2 is a time chart illustrating an exemplary buffer occupancy resulting with a low fixed length jitter buffer;

FIG. 3 is a time chart illustrating an exemplary buffer occupancy resulting with a higher fixed length jitter buffer;

FIG. 4 illustrates an ideal time scaling as a function of a perceived network delay;

FIG. 5 is a time chart illustrating an ideal time scaling;

FIG. 6 is a time chart illustrating an ideal time scaling in which a signal extension failed;

FIG. 7 is a time chart illustrating an unconstrained time scaling with a constant jitter buffer size;

FIG. 8 is a schematic block diagram of a transmission system according to an embodiment of the invention;

FIG. 9 is a flow chart illustrating an operation in the transmission system of FIG. 8;

FIG. 10 is a time chart illustrating a constrained time-scaling within a fixed size window in the transmission system of FIG. 8;

FIG. 11 is a time chart illustrating a constrained time-scaling exceeding a fixed size window in the transmission system of FIG. 8;

FIG. 12 is a time chart illustrating a constrained time-scaling failing to fill up a fixed size window in the transmission system of FIG. 8; and

FIG. 13 is a time chart illustrating an exemplary time-scaling and frame resizing in the transmission system of FIG. 8.

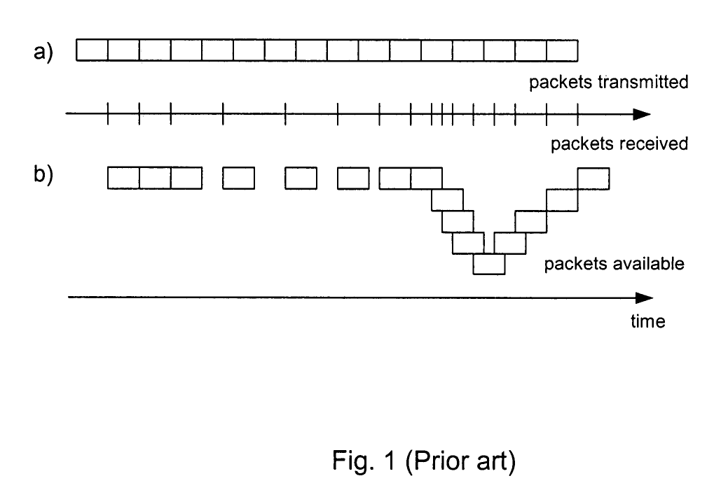

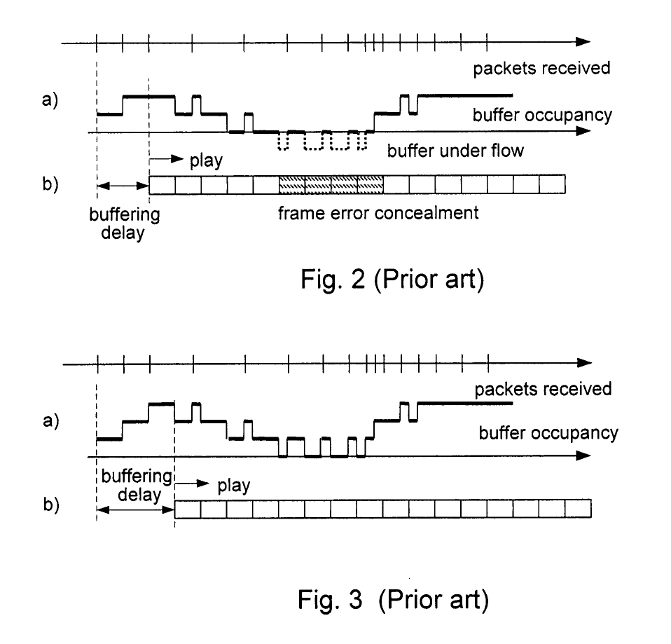

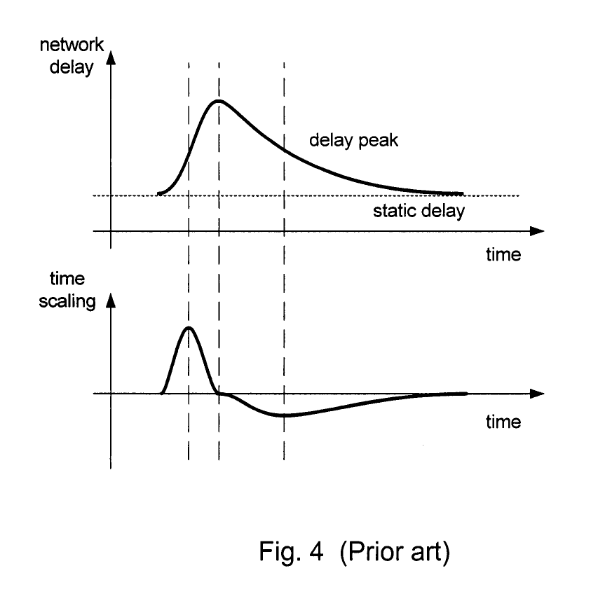

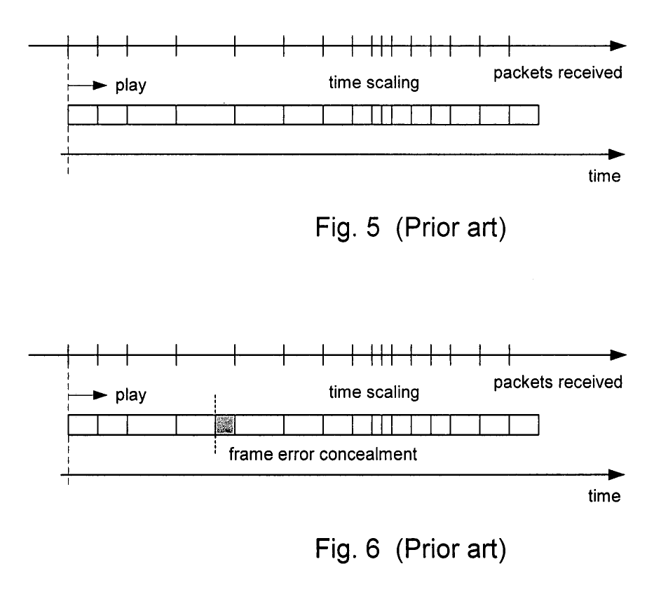

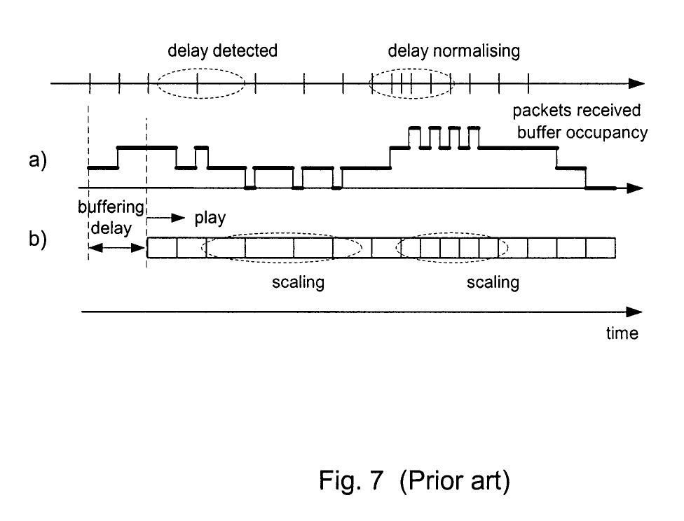

### DETAILED DESCRIPTION OF THE INVENTION

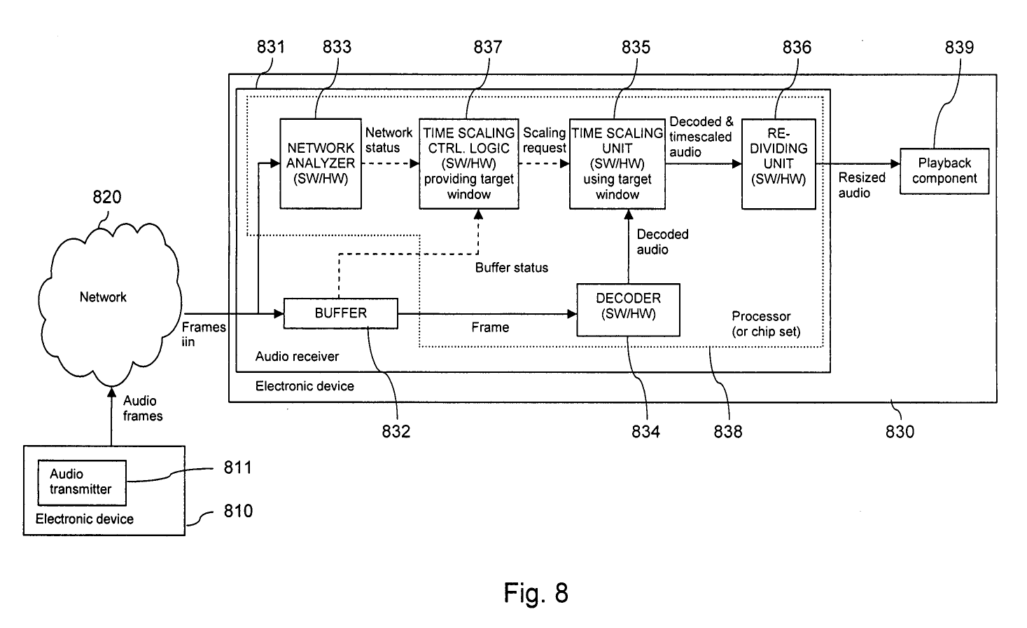

FIG. 8 is a schematic block diagram of an exemplary transmission system, in which an enhanced time-scaling according to an embodiment of the invention may be implemented.

The system comprises an electronic device 810 with an audio transmitter 811, a packet switched communication network 820 and an electronic device 830 with an audio receiver 831. The audio transmitter 811 may transmit packets via the packet switched communication network 820 to the audio receiver 831, each packet comprising an audio frame with encoded audio data.

The input of the audio receiver 831 is connected within the audio receiver 831 on the one hand to a jitter buffer 832 and on the other hand to a network analyzer 833. The jitter buffer 832 is connected via a decoder 834, a time scaling unit 835 and a re-dividing unit 836 to the output of the audio receiver 831. A control signal output of the network analyzer 833 is connected to a first control input of a time scaling control logic 837, while a control signal output of the jitter buffer 832 is connected to a second control input of the time scaling control logic 837. A control signal output of the time scaling control logic 837 is further connected to a control input of the time scaling unit 835.

The components 833 to 837 of the audio receiver 831 may be implemented for instance by software code that can be executed by a processor 838 of the audio receiver 831 or a processor of the electronic device 830. It has to be noted, though, that alternatively the functions of components 833 to 837 could be realized by hardware, for instance by a circuit integrated in a chip or a chipset.

The output of the audio receiver 831 may be connected to a playback component 839 of the electronic device 830, for example to loudspeakers.

It is to be understood that the presented architecture of the audio receiver 831 of FIG. 8 is only intended to illustrate the basic logical functionality of an exemplary audio receiver according to the invention. In a practical implementation, the represented functions can be allocated differently to different processing blocks. Some processing block of an alternative architecture may combine several of the functions described above. A time scaling unit and a re-dividing unit that are combined with a decoder, for example, can provide a computationally very efficient solution. Furthermore, there may be additional processing blocks, and some components, like the buffer 832, may even be arranged outside of the audio receiver 831.

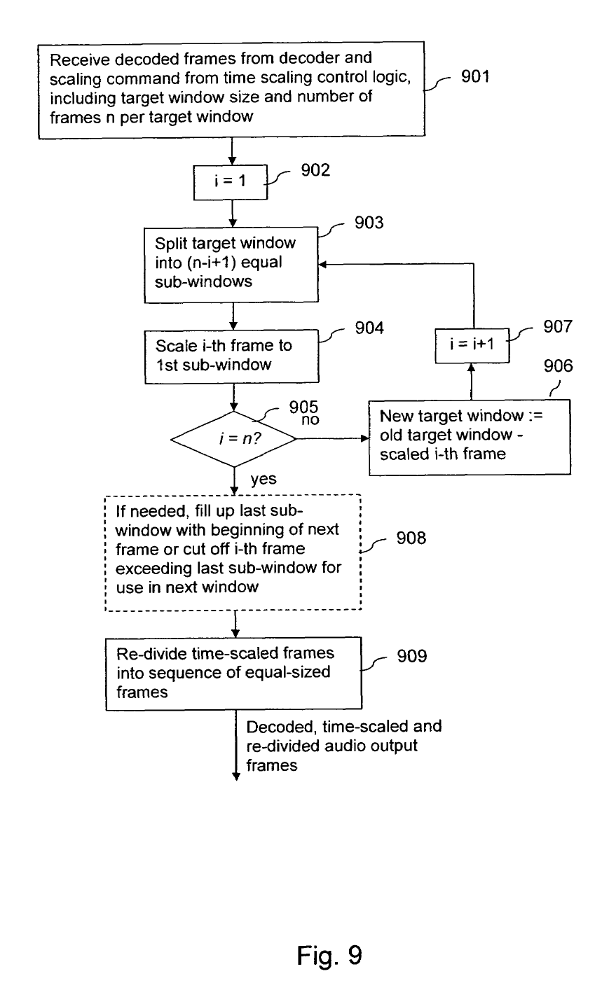

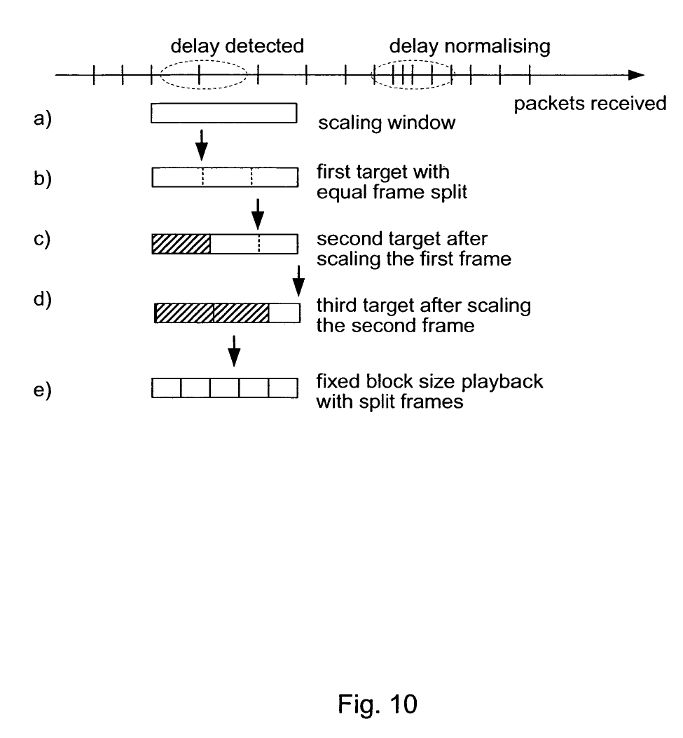

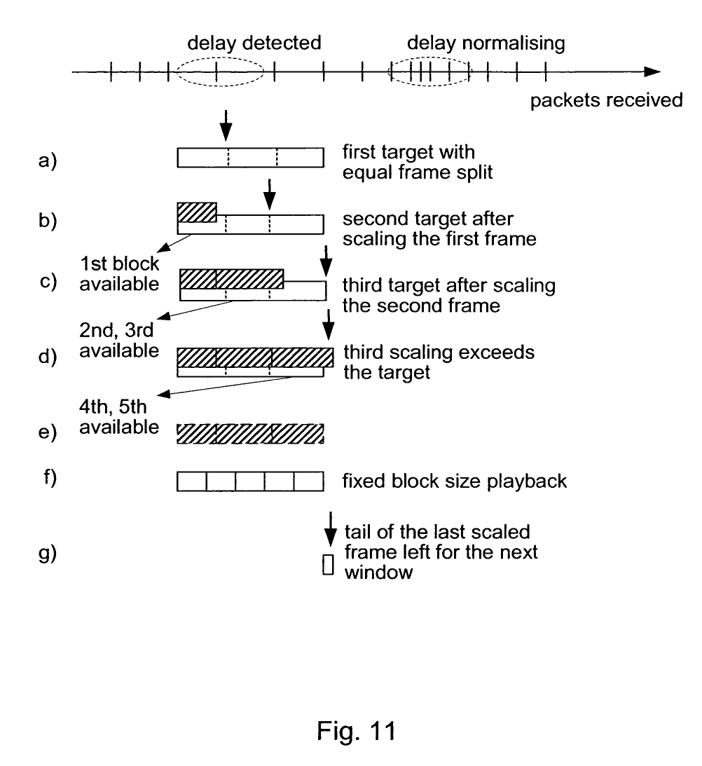

The operation of the audio receiver 831 will now be described with reference to FIGS. 9 and 10. FIG. 9 is a flow chart illustrating specifically the processing in the time scaling unit 835 and the re-dividing unit 836. FIG. 10 is a time chart illustrating an exemplary time-scaling for a single change of the buffer delay.

When the electronic device 830 receives an audio stream from the electronic device 810 via the network 820, the packets comprising the audio frames may be subject to jitter. FIG. 10 presents a time line indicating the time of reception of a respective packet. It can be seen that the first packets are received at a normal rate, the following packets are delayed, then the packets are received at an increased rate so that the delay is normalized again, and finally, the packets are received at a normal rate again.

The audio frames in the received packets are stored in the jitter buffer 832 before they are decoded and played back, in order to mitigate the jitter from the decoder 834. The jitter buffer 832 may have the capability to arrange received frames into the correct decoding order and to provide the arranged frames—or information about missing frames—in sequence to the decoder 834 upon request. In addition, the jitter buffer 832 provides information about its status to the time scaling control logic 837.

The network analyzer 833 computes a set of parameters describing the current reception characteristics based on frame reception statistics and the timing of received frames and provides the set of parameters to the time scaling control logic 837.

When the time scaling control logic 837 detects a need for changing the buffering delay based on the status of the jitter buffer 832 and the information provided by the network analyzer 833, the time scaling control logic 837 gives corresponding time scaling commands to the time scaling unit 835. The used average buffering delay does not have to be an integer multiple of the input frame length. The optimal average buffering delay is the one that minimizes the buffering time without any frames arriving late. Each time alignment command includes an indication of a target window size and an indication of a number of frames. The target window size has a length which is an integer multiple of the lengths of the received audio frames and of desired output frames. The indicated number n of frames determines a number of frames that are to be fit to this target window size by time-scaling. The target window length and the indicated number of frames depend on the respective buffering delay variation. The bigger the requested change in the buffering delay, the longer the selected target window and the fewer the frames that are to be placed into it. Thereby, the time scaling control logic 837 may determine the amount and the speed of the time-scaling.

In the example of FIG. 10, as the packets arrive with a delay the target window length is set to five frames of 20 ms, that is to 100 ms, and the number n of frames that are to be scaled into the target window is set to three. Hence, the scaling is to increase the buffering delay by 40 ms.

The decoder 834 retrieves audio frames from the buffer 832 whenever new data is requested by the playback component 839. It decodes the retrieved audio frames and forwards the decoded audio frames to the time scaling unit 835.

The time scaling unit 835 receives decoded frames from the decoder 834 and scaling commands from the time scaling control logic 837 (step 901).

For time-scaling the first frame i=1 that is received after a scaling command (step 902), the target window depicted in row a) of FIG. 10 is split by the time scaling unit 835 into n−i+1=3 equal sub-windows (step 903), as shown in row b) of FIG. 10.

The first frame is then scaled such that it obtains a similar length as the sub-windows (step 904). The actually achieved length depends on the input signal characteristics and on the employed type of time-scaling.

As long as the scaled frame is not the last one of the number of input frames that are to be scaled (step 905), the process is repeated for the rest of the frames that are to be scaled.

That is, the length of the first scaled frame is determined, and the target window for the remaining frames is revised accordingly, as shown in row c) of FIG. 10 (step 906).

For time-scaling the second frame i=i+1=2 (step 907) the new target window is split by the time scaling unit 835 into n−i+1=2 equal sub-windows (step 903), as shown in row c) of FIG. 10. The second frame is scaled based on the input signal characteristics to fit to the length of the new sub-windows (step 904). Next, the length of the second scaled frame is determined and the target window for the third frame is revised accordingly, as shown in row d) of FIG. 10 (step 906). For time-scaling the third frame i=i+1=3 (step 907) the remaining target window is split by the time scaling unit 835 into n−i+1=1 equal sub-windows (step 903), as shown in row d) FIG. 10. The third frame is then scaled to fit into the remaining target window (step 904).

The number of processed frames i is now equal to the indicated number of frames n. (step 905)

It is to be understood that in a real-time system, such as VoIP, the frames can be given to the time scaling unit 835 one at a time. That is, most probably, not all of the frames within the scaling window are available when a windowed scaling is started.

The time-scaled frames are provided by the time scaling unit 835 to the re-dividing unit 836. The re-dividing unit 836 re-divides the audio signal in the received sequence of time-scaled frames into frames of equal size again (step 909), as indicated in row e) of FIG. 10.

The equal sized frames can now be provided for post-processing and playback to the playback component 839 of the electronic device 830.

When all the n frames for the defined target window are processed, the time scaling control logic 837 evaluates the network conditions again and defines another target window for the next set of n frames if necessary, and the operation starts from the beginning. When the buffering delay is decreased, the same windowing operation and time scaling algorithm is used. In this case, more frames are fitted into the target window by contracting them. It should be noted that when decreasing the delay, the decoder 834 retrieves frames from the jitter buffer 832 more frequently than after a respective nominal 20 ms interval. Therefore, the operation is possible only when the buffer occupancy is sufficient.

The respective number n of frames that is to be fit to the target window depends on the observed delay conditions. As indicated above, the target window length itself might be adjustable as well. The time scaling control logic 837 can use, for example, predetermined scaling profiles for different scaling needs. Table 1 gives an example set of such predefined scaling profile. The profile indicates the size of the target window into which a given number of frames of 20 ms each has to be fitted for obtaining a desired time-scaling. For example, for obtaining an extension of 40 ms by the time-scaling, n=8 frames are fitted into a target window of 200 ms.

| | Window length | Number of | Time scaling |
|---|---|---|---|
| Set | (ms) | frames | target (ms) |
| 1 | 50 | 2 | +10 |
| 2 | 100 | 4 | +20 |
| 3 | 200 | 8 | +40 |
| 4 | 40 | 1 | +20 |
| 5 | 100 | 4 | +40 |
| 6 | 200 | 6 | +80 |
| 7 | 50 | 3 | −10 |
| 8 | 100 | 6 | −20 |
| 9 | 200 | 12 | −40 |
| 10 | 40 | 3 | −20 |
| 11 | 100 | 7 | −40 |
| 12 | 200 | 14 | −80 |

The actual time scaling can be carried out for instance in a conventional manner. It is usually performed based on signal characteristics to provide the best trade-off between resulting audio quality and computational complexity. Typically, the signal extension or contraction is done as multiples of pitch cycles. An example of a suitable time scaling can be found in the document “High quality time-scale modification for speech” by S. Roucos and A. M. Wilgus, IEEE ICASSP 1985, pages 493-496. It is to be understood, however, that other time-scaling approaches can be employed as well.

It has to be noted that in some situations, it may not be possible to fit the selected number n of frames exactly into the selected target window. During silence and clearly unvoiced speech the scaling is less restricted. In these cases it might thus be easier to achieve an exact fit to the scaling window.

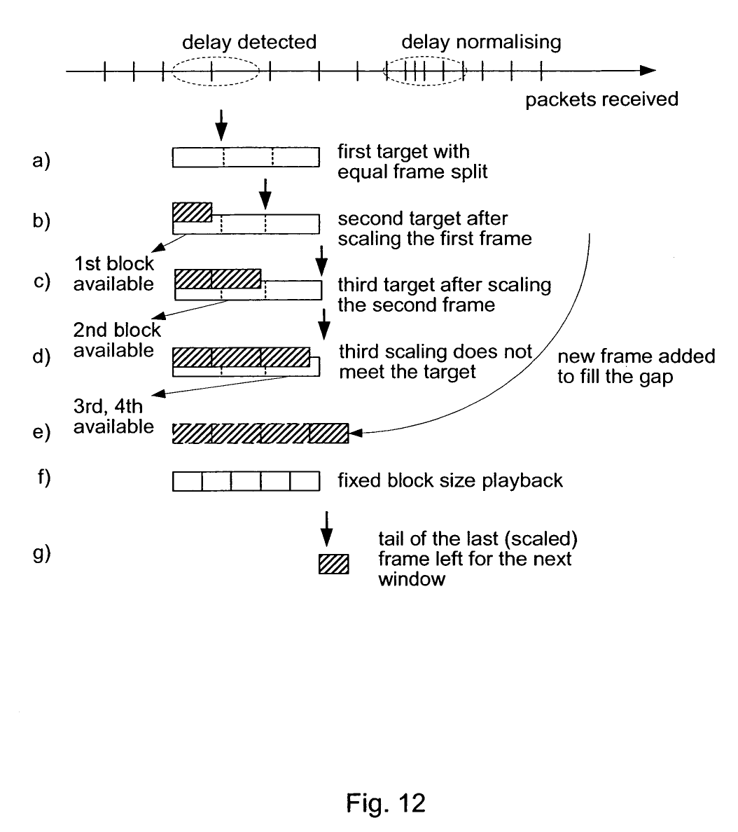

FIGS. 11 and 12 are time charts illustrating an approach that may be used when the time-scaling fails to meet the length of the target window.

In the case of FIG. 11, at first the same operation is carried out as described above with reference to steps 902 to 907 of FIG. 9. These steps are represented in rows a), b) and c) of FIG. 11. However, the last input frame of the selected number n of frames cannot be scaled to fit exactly to the remaining target window. Rather, the scaled frame slightly exceeds the remaining target window, as shown in row d) of FIG. 11.

Before providing the n^{th} scaled frame to the re-dividing unit 836, its tail is therefore cut off and left for the next window, as indicated in rows e), f) and g) of FIG. 11. This step is indicated in FIG. 9 with dashed lines as step 908. The remaining tail has to be stored in a buffer and the time scaling functionality has to continue in the next window.

In the case of FIG. 12, at first again the same operation is carried out as described above with reference to steps 902 to 907 of FIG. 9. These steps are represented in rows a), b) and c) of FIG. 12. However, the last input frame of the selected number n of frames cannot be scaled to fit exactly to the remaining target window. Rather, the frame extension does not quite reach the target length, as shown in row d) of FIG. 12.

When providing the scaled frames to the re-dividing unit 836 for re-dividing the audio signal in the scaled frames into blocks of equal size, the time-scaling unit 835 fetches an additional input frame to fill the gap, as indicated in rows e), f) and g) of FIG. 12. This step is also represented by step 908 of FIG. 9. The tail of this additional input frame is left for the next window.

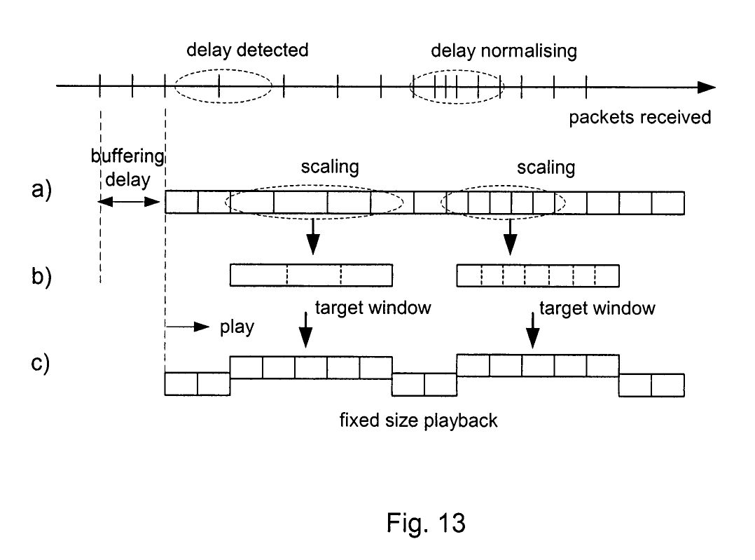

It has to be noted that the proposed windowing operation does not cause any additional delay in the time scaling and buffering operation, since the constant size frames can be extracted from the target window immediately when the scaling of a frame has been completed. This aspect is indicated as well in FIGS. 12 and 13, where equal sized frames of 20 ms are retrieved from the target window.

FIG. 13 is a time chart illustrating an exemplary constrained time-scaling according to the invention for a sequence of changes of the buffer delay. FIG. 13 presents the same time line indicating the time of arrival of the packets for an audio stream as FIG. 10. Further, it illustrates in row a) a scaling of frames to a respective target window shown in row b). In a first situation dealing with an increased jitter buffer delay, the target window has a size of five input frames and the number n of input frames that is to be fit into it is three. It can be seen that the beginning of the next input frame has to be used to fill up the target window completely.

In a second situation dealing with a decreased jitter buffer delay, the target window has equally a size of five input frames, but the number n of input frames that is to be fit into it is seven. It can be seen that in this case, the seven input frames can be scaled exactly to the length of the target window.

FIG. 13 finally presents in row c) the equal sized playback frames that are obtained by re-dividing the audio signal in the time-scaled frames.

Thus, the decoding and time scaling operation is hidden from post-processing and playback. Within a fixed time frame, the number of decoder executions may be different but the number and length of frames delivered for playback are always constant.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for time-scaling an audio signal, wherein said audio signal is distributed to a sequence of frames, said method comprising
time-scaling frames of said sequence of frames whenever needed, resulting in a sequence of variable sized frames; and
re-dividing an audio signal in said sequence of variable sized frames into a sequence of equal sized frames.

2. The method according to claim 1, wherein said time-scaling comprises scaling a given number of frames to fit into a target window of a given size, said given size of said target window being an integer multiple of the size of said equal sized frames.

3. The method according to claim 2, wherein at least one of said given number of frames and said given size of said target window depend on a desired amount scaling.

4. The method according to claim 2, wherein fitting said given number of frames into a target window comprises
a) splitting said target window into a number of equally sized sub-windows corresponding to said given number of frames;
b) fitting a first frame of said given number of frames into a first one of said sub-windows, resulting in a remaining target window;
c) if a next frame of said given number of frames remains, splitting said remaining target window into a number of new equally sized sub-windows corresponding to said remaining number of frames; and
d) fitting said next frame of said given number of frames into a first one of said new sub-windows, resulting in a new remaining target window, and continuing with step c).

5. The method according to claim 4, wherein an actually achieved length of each frame fitted into a sub-window depends on input signal characteristics and on an employed type of time-scaling.

6. The method according to claim 4, wherein in case a time-scaled last frame of said given number of frames exceeds a target window, cutting off the exceeding section and providing it for use in a next target window.

7. The method according to claim 4, wherein in case a time-scaled last frame of said given number of frames does not fill up a target window, adding a first section of a subsequent frame for filling up said target window.

8. The method according to claim 1, wherein said audio signal is received via a packet switched network.

9. A chipset with at least one chip for time-scaling an audio signal that is distributed to a sequence of frames, said at least one chip comprising:
a time scaling component adapted to time-scale frames of an input sequence of frames whenever needed, resulting in a sequence of variable sized frames; and
a re-dividing component adapted to re-divide an audio signal in a sequence of variable sized frames provided by said time scaling component into a sequence of equal sized frames.

10. An audio receiver comprising a time scaling component and a re-dividing component for time-scaling an audio signal that is distributed to a sequence of frames,
said time scaling component being adapted to time-scale frames of an input sequence of frames whenever needed, resulting in a sequence of variable sized frames; and
said re-dividing component being adapted to re-divide an audio signal in a sequence of variable sized frames provided by said time scaling component into a sequence of equal sized frames.

11. An electronic device comprising a time scaling component and a re-dividing component for time-scaling an audio signal that is distributed to a sequence of frames,
said time scaling component being adapted to time-scale frames of an input sequence of frames whenever needed, resulting in a sequence of variable sized frames; and
said re-dividing component being adapted to re-divide an audio signal in a sequence of variable sized frames provided by said time scaling component into a sequence of equal sized frames.

12. The electronic device according to claim 11, wherein said time scaling component is adapted to apply a time-scaling which comprises scaling a given number of frames to fit into a target window of a given size, said given size of said target window being an integer multiple of the size of said equal sized frames.

13. The electronic device according to claim 12, wherein fitting said given number of frames into a target window comprises
a) splitting said target window into a number of equally sized sub-windows corresponding to said given number of frames;
b) fitting a first frame of said given number of frames into a first one of said sub-windows, resulting in a remaining target window;
c) if a next frame of said given number of frames remains, splitting said remaining target window into a number of new equally sized sub-windows corresponding to said remaining number of frames; and
d) fitting said next frame of said given number of frames into a first one of said new sub-windows, resulting in a new remaining target window, and continuing with step c).

14. The electronic device according to claim 11, wherein said audio signal is received via a packet switched network.

15. A system comprising a transmission network adapted to transmit audio signals, a transmitter adapted to provide audio signals for transmission via said transmission network and a receiver adapted to receive audio signals via said transmission network, said receiver including a time scaling component and a re-dividing component for time-scaling an audio signal that is distributed to a sequence of frames,
said time scaling component being adapted to time-scale frames of an input sequence of frames whenever needed, resulting in a sequence of variable sized frames; and
said re-dividing component being adapted to re-divide an audio signal in a sequence of variable sized frames provided by said time scaling component into a sequence of equal sized frames.

16. The system according to claim 15, wherein said transmission network is a packet switched network.

17. A software program product in which a software code for time-scaling an audio signal is stored in a readable medium, wherein said audio signal is distributed to a sequence of frames, said software code realizing the following steps when being executed by a processor:
time-scaling frames of said sequence of frames whenever needed, resulting in a sequence of variable sized frames; and
re-dividing an audio signal in said sequence of variable sized frames into a sequence of equal sized frames.

18. The software program product according to claim 17, wherein said time-scaling comprises scaling a given number of frames to fit into a target window of a given size, said given size of said target window being an integer multiple of the size of said equal sized frames.

19. The software program product according to claim 18, wherein fitting said given number of frames into a target window comprises
a) splitting said target window into a number of equally sized sub-windows corresponding to said given number of frames;
b) fitting a first frame of said given number of frames into a first one of said sub-windows, resulting in a remaining target window;
c) if a next frame of said given number of frames remains, splitting said remaining target window into a number of new equally sized sub-windows corresponding to said remaining number of frames; and
d) fitting said next frame of said given number of frames into a first one of said new sub-windows, resulting in a new remaining target window, and continuing with step c).
